(19) United States
(12) Patent Application Publication
(10) Pub. No.: US 2025/0303810 A1
(43) Pub. Date: Oct. 2, 2025

(54) ADAPTIVE SPRING RATE SYSTEM

(71) Applicant: Fox Factory, Inc., Duluth, GA (US)

(72) Inventors: Connor Randall, Salida, CO (US); Camden Gillis, Salida, CO (US); Edwin Blake Nicholas, Elbert, CO (US)

(73) Assignee: Fox Factory, Inc., Duluth, GA (US)

(21) Appl. No.: 18/624,681

(22) Filed: Apr. 2, 2024

(51) Int. Cl. B60G 17/052; B60G 17/015

(52) U.S. Cl. CPC B60G 17/0528; B60G 17/0155; B60G 2500/2014; B60G 2500/2042

(57) ABSTRACT

A multi-rate adaptive spring system. A first spring with a first spring rate. A second spring with a second adaptive spring rate. The second spring comprising a damper portion, a hydraulic piston, and an additional volume reservoir. The additional volume reservoir comprising a fluid filled portion, a gas filled portion, and a floating piston.

### FIELD OF THE INVENTION

Embodiments of the invention generally relate to a multi-rate spring system that comprises a first spring with a first spring rate and a second spring with a second variable spring rate.

### BACKGROUND

Shock assemblies (e.g., dampers, shock absorbers, springs etc.) are used in numerous different vehicles and configurations to absorb some or all of a movement that is received at an unsprung portion of a vehicle before it is transmitted to a suspended portion of the vehicle. For example, when a wheel hits a pothole, the encounter will cause an impact force on the wheel. However, by utilizing suspension components including one or more shock assemblies, the impact force can be significantly reduced or even absorbed completely before it is transmitted to a person on a seat of the vehicle. However, depending upon the terrain being traversed, it can be valuable to be able to change the amount of shock absorption provided by the shock assembly, including changing the type of springs, for personal comfort, vehicle performance, and the like.

### BRIEF DESCRIPTION OF THE DRAWINGS

Aspects of the present invention are illustrated by way of example, and not by way of limitation, in the accompanying drawings, wherein:

FIGS. 1A-D, are side views of a dual rate spring system, in accordance with an embodiment.

FIGS. 2A-B, are graphs which depict overall spring curves of a dual rate spring system, in accordance with an embodiment.

FIG. 3, is a side view of a dual rate spring system with a two-way valve, in accordance with an embodiment.

FIG. 4, is a side view of a dual rate spring system with a fluid pump and a gas pump, in accordance with an embodiment.

FIG. 5A, is a graph of a force displacement curve of a dual rate spring system, in accordance with an embodiment.

FIG. 5B, is a graph of a force displacement curve of a sing rate spring system with a single spring, in accordance with an embodiment.

FIG. 6, is a side view of a dual rate spring system with an volume adjusting actuator, in accordance with an embodiment.

FIGS. 7A-B, are side views of a dual rate spring system with a second additional volume reservoir, in accordance with an embodiment.

FIGS. 8A-B, are graphs which depict a force displacement curve for bump stop embodiments, in accordance with an embodiment.

FIG. 9, is a side view of a dual rate spring system including piston limits and spring limits, in accordance with an embodiment.

FIG. 10, is a side view of a dual rate spring system with a gas filled portion directly above and in line with a first spring and a damper portion, in accordance with an embodiment.

FIG. 11, is a side view of a dual rate spring system with a second floating piston, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

In general, a suspension system with one or more springs for a vehicle provides a motion modifiable connection between a portion of the vehicle that is in contact with a surface (e.g., an unsprung portion) and some or all of the rest of the vehicle that is not in contact with the surface (e.g., a suspended portion). A vehicle utilizing a suspension system can have a one or more air shocks. The vehicle may be a wheeled vehicle or any other type of vehicle including snowmobiles. Implementations of the present invention other than vehicles may include, but are not limited to, an exoskeleton, a seat frame, a prosthetic, a suspended floor, a door opening/closing damper, a lift assist damper, or any other application where a controlled compression and/or rebound of a suspension/damper is desired. However, in the following discussion, and for purposes of clarity, a vehicle may be described.

A conventional shock can provide suspension to a vehicle with a spring rate or spring curve. A conventional shock can be a mechanical spring. A graph of the spring rate can depict force displacement curve meaning a spring force as a function of position or travel of the shock. The spring rate of a mechanical spring can be substantially linear. In order to tune or adjust the spring rate of a convention shock, the mechanical spring may be changed for a different mechanical spring with a different spring rate.

A conventional dual spring system can have two mechanical springs in series with one another. The dual springs have spring rates that are different from one another and can use a spring coupler to couple the dual springs to one another as well as a crossover ring to create a crossover point where the conventional dual spring system will change from the spring rate of a first spring to the spring rate of the second spring. To adjust a spring rate in a conventional dual spring system, one or both of the mechanical springs may be changed for different mechanical springs with a different spring rates.

In contrast, the dual rate spring systems of the present invention include a first spring with a first spring rate in series with a second spring with a second spring rate that is adjustable or tunable. For example, the first spring can be a mechanical spring while the second spring can be a hydraulic spring system with an additional chamber. The hydraulic spring system has a second spring rate that is tunable or adjustable. Therefore, the dual rate spring systems of the present invention can adjust a spring rate without changing a mechanical spring for a different mechanical spring. The dual rate spring systems of the present invention can also be used to adjust ride height of a vehicle or provide bottom out resistance.

### Hydraulic Dual Rate Spring

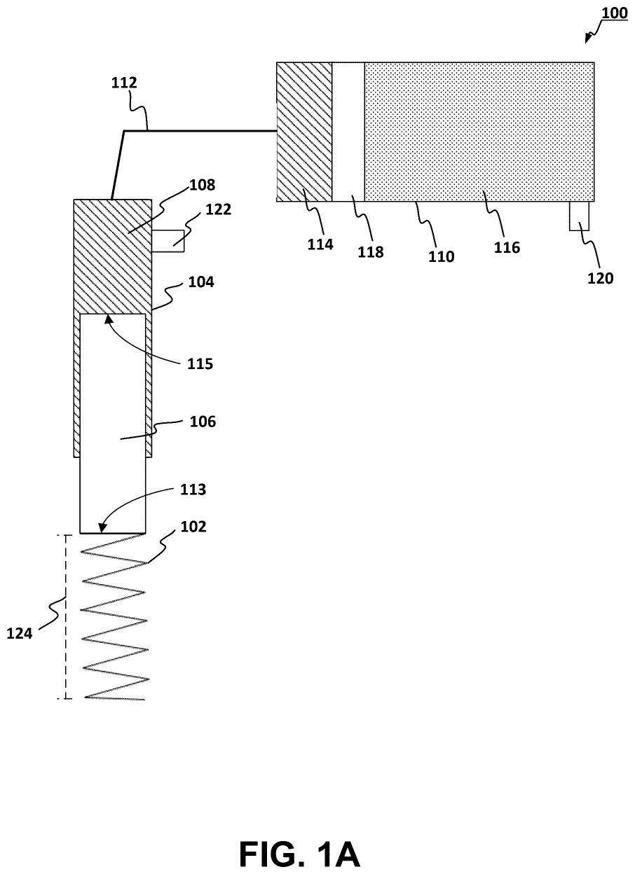

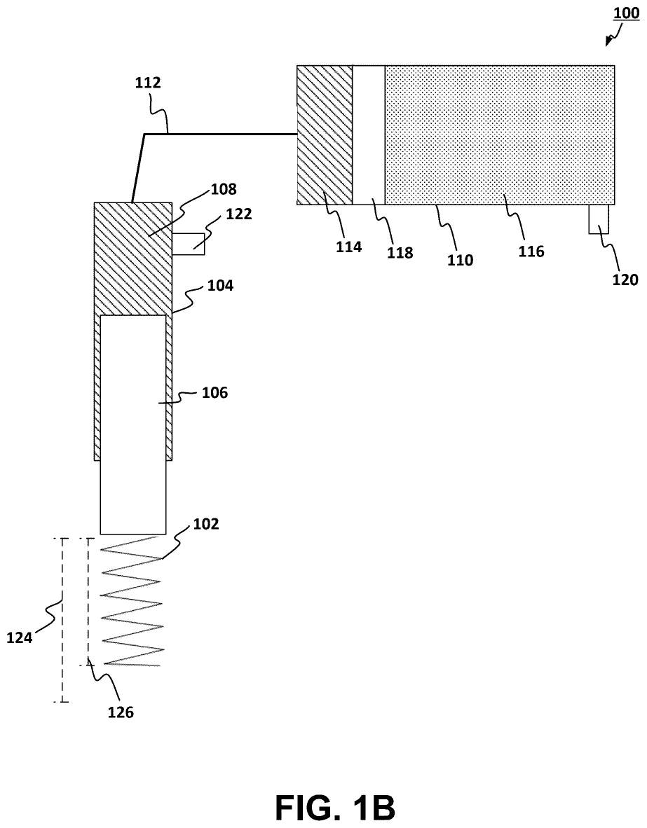

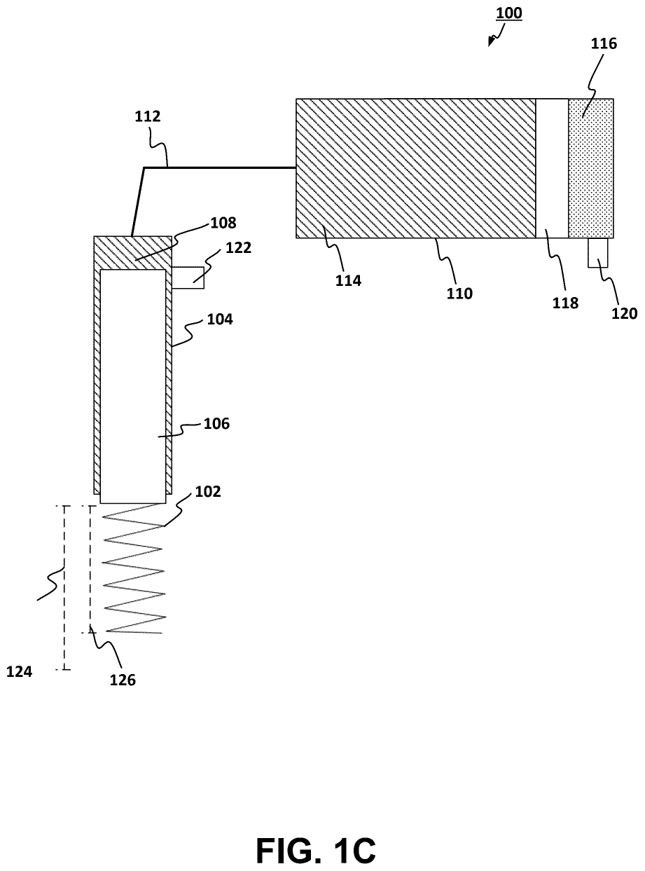

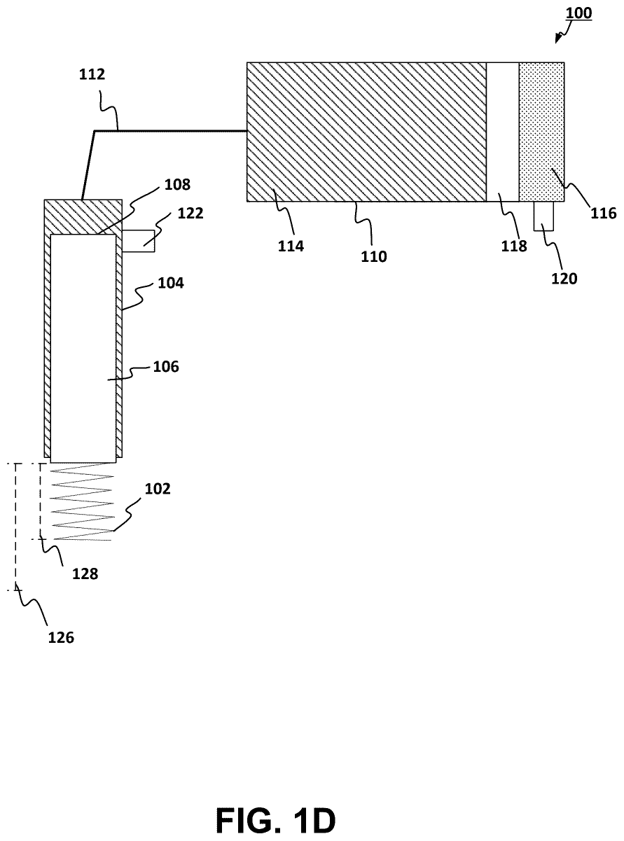

With reference now to FIGS. 1-D, side views of a dual rate spring system 100 are provided. Dual rate spring system 100 includes a first spring 102, a second spring 104, a hydraulic piston 106, a damper portion 108, an additional volume reservoir 110, and a fluid pathway 112.

First spring 102 can have a first spring rate and second spring 104 can have a second spring rate that is the same or different than the first spring rate. In one embodiment, first spring 102 is a mechanical spring. It should be appreciated that first spring 102 can be any type of spring including a mechanical spring, a coil spring, an air spring, etc. First spring 102 may or may not be adjustable or tunable. First spring 102 can be connected in series to second spring 104. For example, surface 133 of hydraulic piston 106 can be in contact with an end of first spring 102. First spring 102 can be connected in series to second spring 104 as a dual rate spring system that does not include a crossover ring or crossover stop and can be described as a non-coilover application. In one embodiment, the dual rate spring system of the present invention can be used in an application that typically employs or requires a single rate spring such as a non-coilover application. It should be appreciated that the dual rate spring systems of the present invention can be implemented into embodiments with more than two springs such as three springs.

Second spring 104 can be a hydraulic spring. Second spring 104 can provide damping that is either mechanical or semi-active. The second spring 104 includes a hydraulic piston 106 with surface 115 that can telescopically move into and out of a damper portion 108 during compression and rebound events of second spring 104. Hydraulic piston 106 can be a ram. Second spring 104 can include an additional volume reservoir 110. Damper portion 108 can be in fluid communication, via a fluid pathway 112, with a fluid filled portion 114 of additional volume reservoir 110. Fluid filled portion 114 can be separated from a gas filled portion 116 via a floating piston 118. The fluid that fills damper portion 108 and fluid filled portion 114 can be a non-compressible fluid and can be oil. Floating piston 118 can movable operate within the additional volume reservoir 110 based on a pressure of the fluid in damper portion 108 and fluid filled portion 114 as well as a pressure of the gas in gas filled portion 116. Gas filled portion 116 can be filled with a gas that can be nitrogen or can be air and can be compressible. Floating piston 118 can be an internal floating piston that can move within the additional volume reservoir 110 based on a pressure or volume of the fluid in fluid filled portion 114 and a pressure or volume of the gas in gas filled portion 116. For example, during a compression event, more fluid may enter fluid filled portion 114 via fluid pathway 112 at a proximal end of additional volume reservoir 110 and cause floating piston 118 to be displaced towards the distal end of additional volume reservoir 110 compressing the gas in gas filled portion 116. In one embodiment, the fluid in damper portion 108 and fluid filled portion 114 is a hydraulic column between two springs (e.g. first spring 102 and gas filled portion 116).

It should be appreciated that additional volume reservoir 110 can be physically coupled to a main body of second spring 104 or can be located physically remote from a main body of second spring 104 as is depicted. The main body of second spring 104 and additional volume reservoir 110 can be cylindrical in shape or can be any other shape.

In one embodiment, second spring 104 can be tunable or adjustable such that the spring rate (described above as the second spring rate) of second spring 104 can be changed. In one embodiment, a spring rate of second spring 104 can be adjusted by adding or removing gas to gas filled portion 116 via gas valve 120. Gas valve 120 can be a standard gas valve such as a Schrader valve. In one embodiment, a spring rate of second spring 104 can be adjusted by adding or removing fluid to damper portion 108 and/or fluid filled portion 114 via fluid valve 122. In one embodiment, fluid valve 122 can be located on additional volume reservoir 110. In one embodiment, damper portion 108 and fluid filled portion 114 can each have a fluid valve. Adjusting the spring rate of second spring 104 can include adding or removing gas, adding or removing fluid, or a combination of both. Tuning, adjusting, or otherwise changing a spring rate of second spring 104 can change the overall spring rate of dual rate spring system 100. Thus the overall spring rate of dual rate spring system 100 can be changed without changing a mechanical spring (first spring 102) for a different mechanical spring.

FIG. 1A depicts a nearly fully extended state of hydraulic piston 106 with respect to damper portion 108. First spring 102 can be nearly fully extended or at a resting state where first spring 102 is extended or resting at distance 124.

FIG. 1B depicts dual rate spring system 100 with first spring 102 partially compressed to distance 126. Distance 126 is depicted as a shorter distance than distance 124. During the initial stages of a compression event, the force of the compression event may be enough to partially compress first spring 102 without compressing second spring 104 as is depicted in FIG. 1B.

FIG. 1C depicts first spring 102 compressed to distance 126, as depicted in FIG. 1B, and with second spring 104 nearly fully compressed. Hydraulic piston 106 is depicted as being nearly fully inserted into damper portion 108. With hydraulic piston 106 nearly fully inserted into damper portion 108, fluid in damper portion 108 is displaced into fluid filled portion 114 of additional volume reservoir 110. The additional fluid in fluid filled portion 114 has displaced floating piston 118 towards the distal end of additional volume reservoir 110 away from fluid pathway 112. In this nearly fully compressed state of second spring 104, gas in gas filled portion 116 is nearly fully compressed. In one embodiment, second spring 104 can compress, including nearly fully compressing, after first spring 102 has partially compressed and before fully compressing first spring 102.

FIG. 1D depicts dual rate spring system 100 with first spring 102 nearly fully compressed and second spring 104 nearly fully compressed. First spring 102 is depicted as being compressed to distance 128 which is shorter than distance 126. First spring 102 may be nearly fully compressed after second spring 104 has been nearly fully compressed.

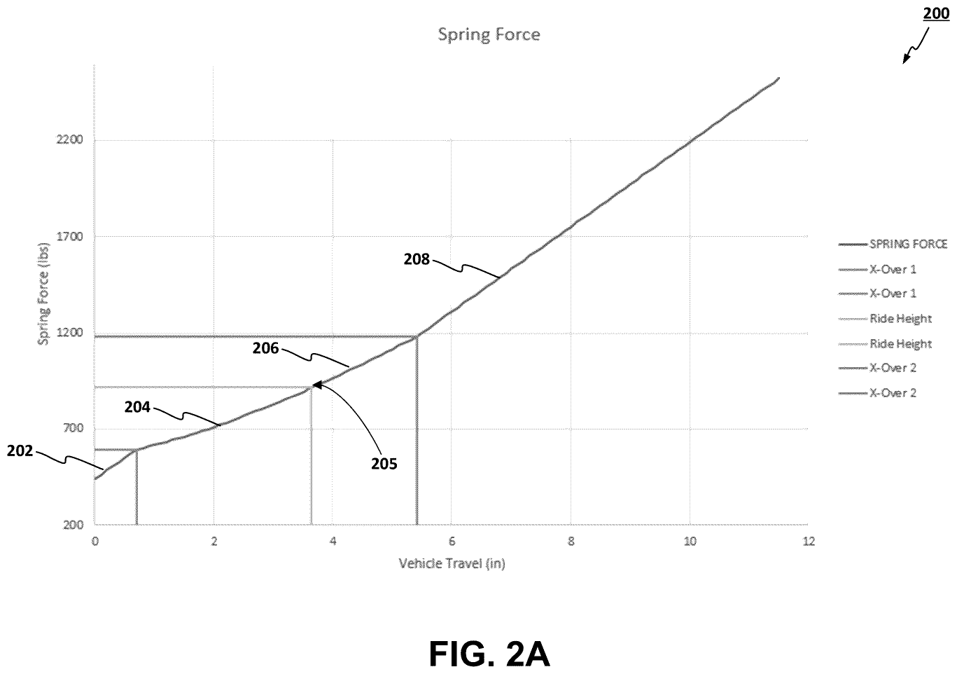

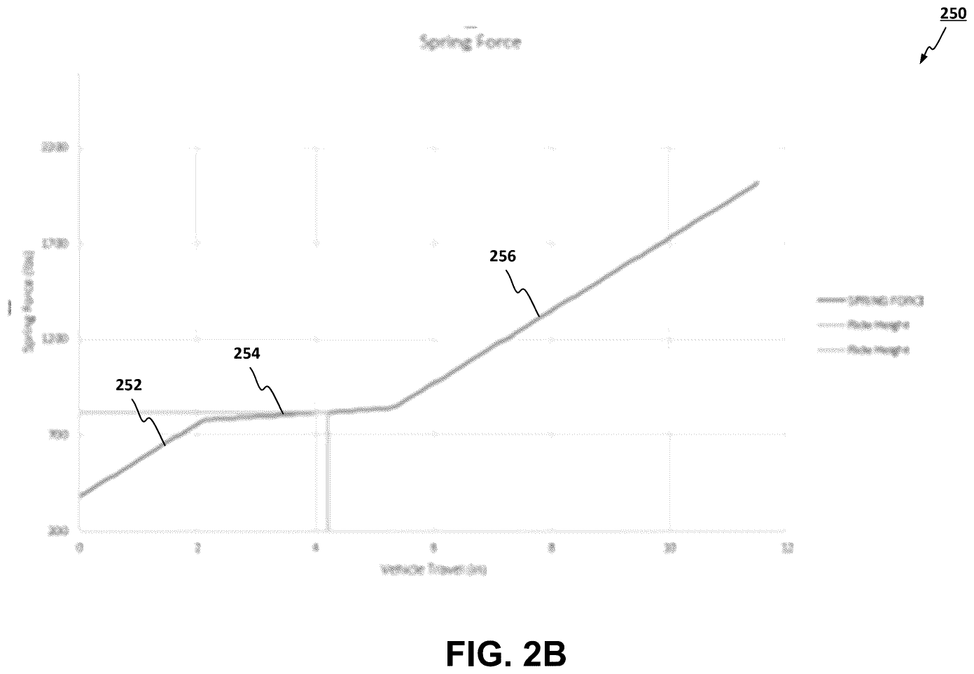

With reference now to FIG. 2A, a graph 200 which depicts an overall spring curve of a dual rate spring system such as dual rate spring system 100 of FIGS. 1A-D. The overall spring curve of the dual rate spring system has different sections with different rates of slope or curve. For example, curve 202 is depicted as substantially linear and can represent an initially a force displacement curve of the first spring being partially compressed without compressing the second spring as is depicted in FIG. 1B. Curve 202 can represent first spring 102 supporting the vehicle's load. Curve 204 and curve 206 is depicted a progressive curve where the first spring remains partially compressed and the second spring goes from nearly fully extended to nearly fully compressed as is depicted in FIG. 1C. The transition from curve 202 to curve 204 can depict where a gas pressure of gas filled portion 116 is overcome. Intersection 205 depicts a ride height of a vehicle. The dual rate spring system can be tuned or adjusted so that the vehicle ride height can be in the middle of the force displacement curve of the second spring being compressed as is depicted. Curve 208 depicts a substantially linear slope or curve that can occur after the second spring has been nearly fully compressed and the first spring then compresses further to a nearly fully compressed state as is depicted in FIG. 1D.

The dual rate spring system of the present invention with a tunable or adjustable second spring can allow for unique overall spring curves as is depicted in graph 200. For example, graph 200 depicts an overall spring curve or force displacement curve that starts as a linear slope, changes to a progressive slope, and then changes back again to a linear curve. By adjusting a ride height of a vehicle to be in between curve 204 and curve 206, the vehicle may be provided with a smoother ride. While curve 204 and curve 206 may be more progressive than linear, curve 204 and curve 206 are depicted having a less steep slope as compared to curve 202 and curve 208. The less steep slope of curve 204 and curve 206 can provided the smoother ride for the vehicle and passengers for smaller bumps (e.g. washboard road) and then provide the steeper curve of curve 208 for larger bumps (e.g. landing a jump) during operation of the vehicle. This can be described as the second spring having softer springs within the ride range of the vehicle as compared to the first spring that can be used outside of the ride range of the vehicle. Embodiments of the dual rate spring systems described herein that are tunable or adjustable can provide for a spring or shock system that is velocity dependent rather than position dependent.

With reference now to FIG. 2B, a graph 250 which depicts an overall spring curve of a dual rate spring system such as dual rate spring system 100 of FIGS. 1A-D. Graph 250 as compared to graph 200 depicts a more extreme example of changing slopes between the first spring and the second spring for isolation of vibration. For example, curve 252 and curve 256 are depicted as having a substantially linear curve similar to curve 202 and curve 208. However, curve 254 is depicted a less steep curve as compared to curve 252 and curve 256 and less steep as compared to curve 204 and curve 206 of graph 200. The less steep curve 254 can provide for a smoother ride in the ride zone including reducing vibrations from components such as an engine.

Hydraulic Dual Rate Spring With a Two-Way Valve

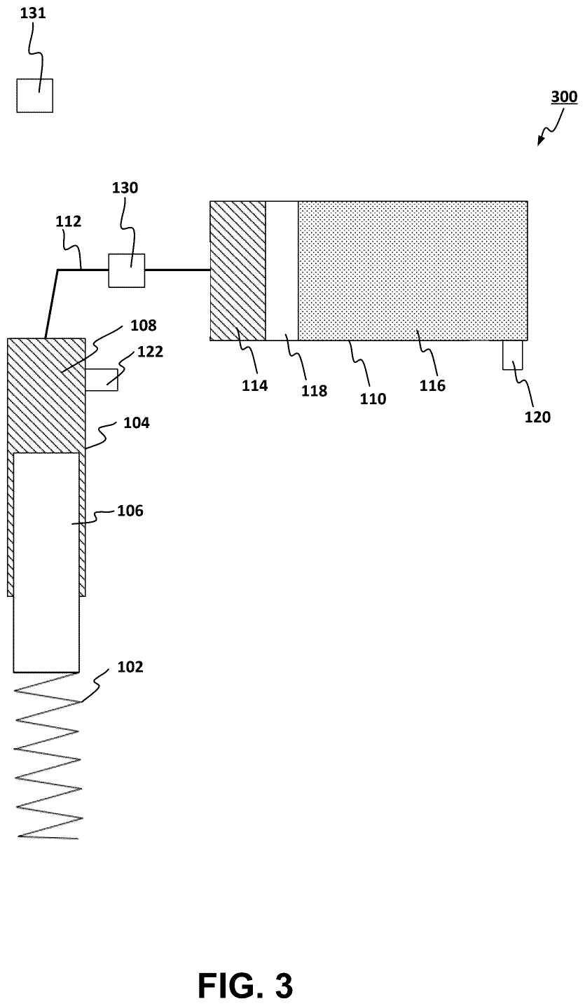

With reference now to FIG. 3, a dual rate spring system 300 with a two-way valve 130 and a vehicle sensor 131. Dual rate spring system 300 can have the same features and capabilities of dual rate spring system 100 of FIGS. 1A-D. Two-way valve 130 can be coupled with, a part of, inside of, or otherwise integrated with fluid pathway 112. Alternatively, two-way valve 130 can be located at either end of fluid pathway 112. Alternatively, two-way valve 130 can be located in damper portion 108 or fluid filled portion 114. In one embodiment, the two-way valve 130 can be or can include a solenoid such as a normally open solenoid valve. In one embodiment, the two-way valve 130 can be described as a check system for dual rate spring system 300.

Two-way valve 130 can be used to check or otherwise control a fluid flow of fluid between damper portion 108 and fluid filled portion 114. In a compression direction, fluid can flow from damper portion 108 to the fluid filled portion 114. In a rebound direction, fluid can flow fluid filled portion 114 to damper portion 108. Two-way valve 130 can check or control fluid flow rates such that fluid flowing in a compression direction can flow at a different rate than fluid flowing in a rebound direction. In other words, two-way valve 130 can control fluid in a first direction at a first rate and fluid in a second direction at a second rate. In one embodiment, two-way valve 130 can fully or nearly fully extend second spring 104 as the vehicle moves through travel. In one embodiment, two-way valve 130 can be split up into two separate valves.

Two-way valve 130 can be used to adjust ride height of a vehicle implementing dual rate spring system 300. The ride height can be adjusted for different weights of vehicles including different amounts of weight of cargo or passengers. Two-way valve 130 can allow for changes in ride height without changing a mechanical spring of the dual rate spring system or without making mechanical spring preload adjustments.

In one embodiment, two-way valve 130 can be adjusted to provide different flow rates in different directions based on position of travel. For example, two-way valve 130 can be adjusted or designed such that fluid can flow from fluid filled portion 114 to damper portion 108 but not the back into fluid filled portion 114 in order to provide additional preload as the vehicle goes through stroke. In this example, after a compression event and hydraulic piston 106 has travelled into damper portion 108, two-way valve 130 allows the fluid to flow from fluid filled portion 114 to damper portion 108 to cause hydraulic piston 106 to fully rebound and extend out of damper portion 108 and the vehicle is returned to ride height. After hydraulic piston 106 has been fully extended out of damper portion 108, two-way valve 130 can change to allow the fluid to flow back to fluid filled portion 114 during a subsequent compression event. Alternatively, the ride height may be set to a predetermined distance where hydraulic piston 106 is extended from the damper portion 108 at the predetermined distance as opposed to fully extended. In one embodiment, to set ride height, gas may be added to gas filled portion 116 until hydraulic piston 106 is in a fully extended position relative to damper portion 108. In another example, two-way valve 130 can be set to open in both direction such that dual rate spring system 300 can function as though no valve is present.

In one embodiment, two-way valve 130 is a mechanical valve. In one embodiment, two-way valve 130 is a passive valve. In one embodiment, two-way valve 130 is an electronic valve that can be controlled remotely. For example, a electronic valve can be controlled by a control device located on the dashboard of the vehicle. In another example, the electronic valve can be controlled by a mobile device such as a laptop or smartphone.

### Hydraulic Dual Rate Spring With Pumps

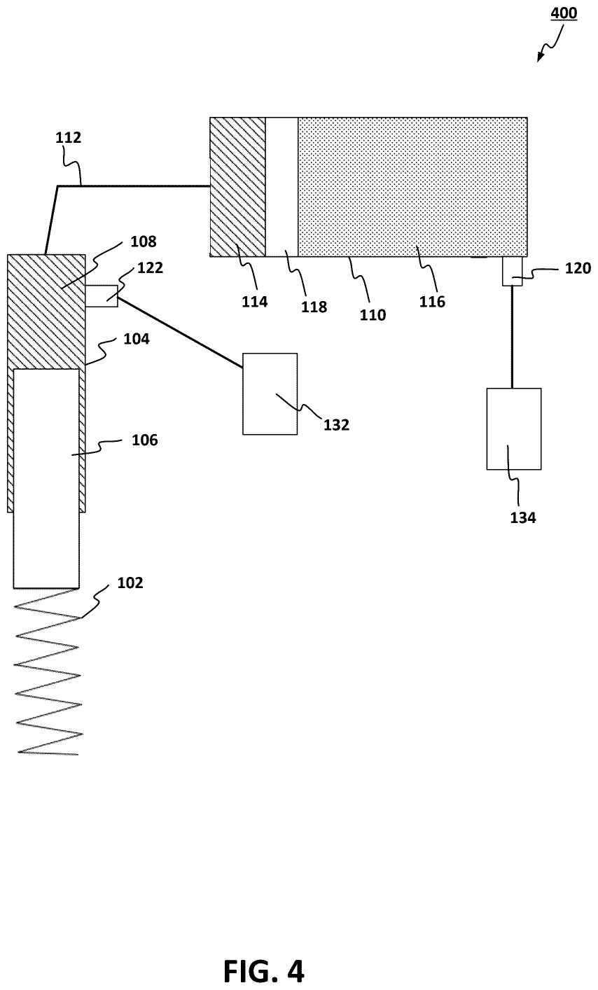

With reference now to FIG. 4, a dual rate spring system 400 with a fluid pump 132 and a gas pump 134. Dual rate spring system 400 can have the same features and capabilities of dual rate spring system 100 of FIGS. 1A-D and/or dual rate spring system 300 of FIG. 3. Fluid pump 132 and gas pump 134 can be used to drive, tune, or adjust dual rate spring system 400 to a desired setting. For example, fluid pump 132 and gas pump 134 can be used to control, adjust or set a ride height for a vehicle. It should be appreciated that dual rate spring system 400 can include fluid pump 132 and not gas pump 134 or gas pump 134 and not fluid pump 132 or can include both. In one embodiment, dual rate spring system 400 can include one or more pumps, such as fluid pump 132 or gas pump 134, as well as a two-way valve such as two-way valve 130.

Fluid pump 132 can be an electrical or a manual pump such as a hand pump. Fluid pump 132 can be a hydraulic pump. Fluid pump 132 can be coupled to and a part of dual rate spring system 400 or can be a detachable component. Fluid pump 132 can be attached to fluid valve 122 or can bypass fluid valve 122 and be directly connected to damper portion 108. Fluid pump 132 can be associated with more than one dual rate spring systems. In one embodiment, fluid pump 132 can add or remove fluid from damper portion 108. Fluid pump 132 is depicted as being connected to damper portion 108 but can alternatively be connected to fluid filled portion 114. Adding fluid to damper portion 108 and fluid filled portion 114 can increase the volume occupied by fluid filled portion 114 and therefore increase pressure on gas filled portion 116 and change the spring rate of second spring 104. In one embodiment, fluid pump 132 is a self-pumping base valve coupled with damper portion 108.

Gas pump 134 can be an electrical or a manual pump such as a hand pump. Gas pump 134 can be a pneumatic pump. Gas pump 134 can be coupled to and a part of dual rate spring system 400 or can be a detachable component. Gas pump 134 can be attached to gas valve 120 or can bypass gas valve 120 and be directly connected to gas filled portion 116. Gas pump 134 can be associated with more than one dual rate spring systems. For example, gas pump 134 can be part of an on-board air system associated with the vehicle. In one embodiment, gas pump 134 can add or remove gas from gas filled portion 116. Adding gas to gas filled portion 116 can increase the volume occupied by or the pressure in gas filled portion 116 and therefore change the spring rate of second spring 104.

For embodiments where fluid pump 132 and gas pump 134 are electronic, fluid pump 132 and gas pump 134 can be controlled by an electronic device associated with the vehicle or can be controlled by a mobile device such as a laptop or smartphone. In one embodiment, fluid pump 132 or gas pump 134 can be an accumulator.

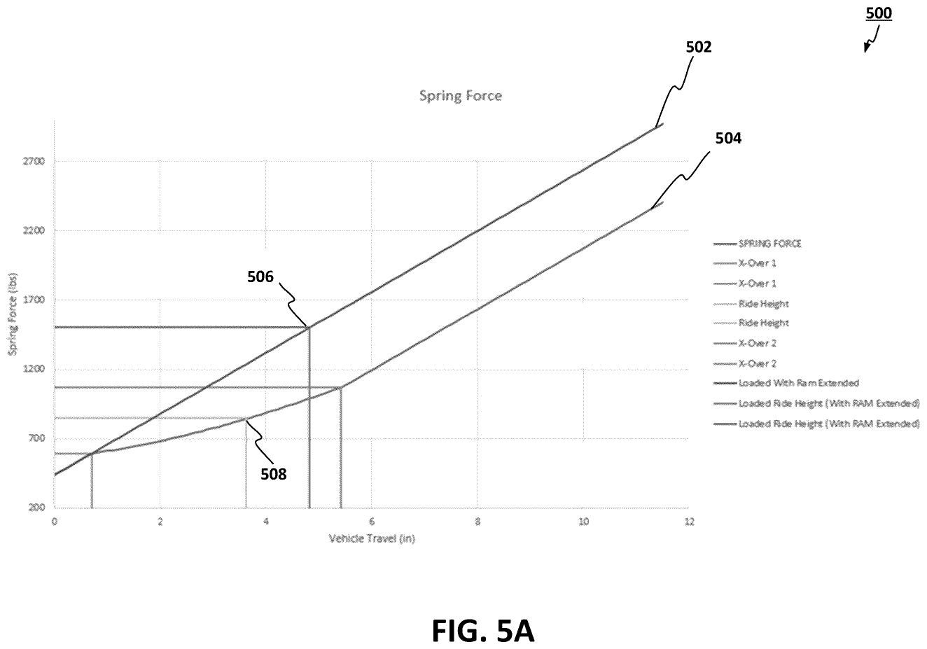

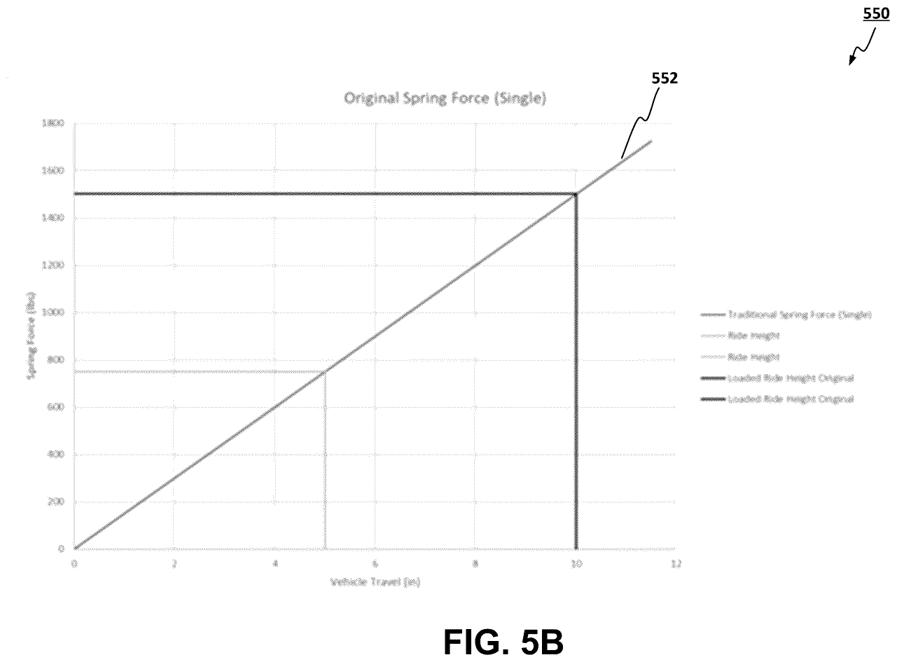

With reference now to FIG. 5A, a graph 500 of a force displacement curve of a dual rate spring system where spring force is a function of travel of the shock. Curve 502 depicts a spring force curve associated with a dual rate spring system of the present technology the same or similar to the spring force curve of graph 200 of FIG. 2A. Curve 504 depicts a spring force curve for a loaded vehicle with a dual rate spring system with hydraulic piston 106 fully extended. A two-way valve, such as two-way valve 130 of FIG. 4, can be used to adjust or switch a spring rate of a dual rate spring system between curve 502 and curve 504. For example, a vehicle with a dual rate spring system may be switched to a spring rate with a curve such as 504 and then a user of the vehicle may switch the two-way valve to put the dual rate spring system into a spring rate with a curve such as curve 502 when a performance mode is desired. Changing a spring rate for a dual rate spring system between curve 502 and 504 may change a ride height of the vehicle as can be observed at ride height 506 of curve 502 compared to ride height 508 of curve 504. Ride height 506, with a hydraulic piston fully extended, is depicted as higher than ride height 508.

With reference now to FIG. 5B, a graph 550 of a force displacement curve of a sing rate spring system with a single spring where spring force is a function of travel of the shock. Curve 552 depicts a spring force of curve 552 which is similar to or the same as curve 502 of graph 500 of FIG. 5A. This demonstrates that a dual rate spring system of the present invention can use adjustments, such as adjustments with a two-way valve or pumps, to make a dual rate spring system have a spring curve similar to curve 552 of a traditional single spring and then make adjustments to change the spring curve of the dual rate spring system which a traditional single spring may not be able to do.

### Hydraulic Dual Rate Spring With a Volume Adjusting Actuator

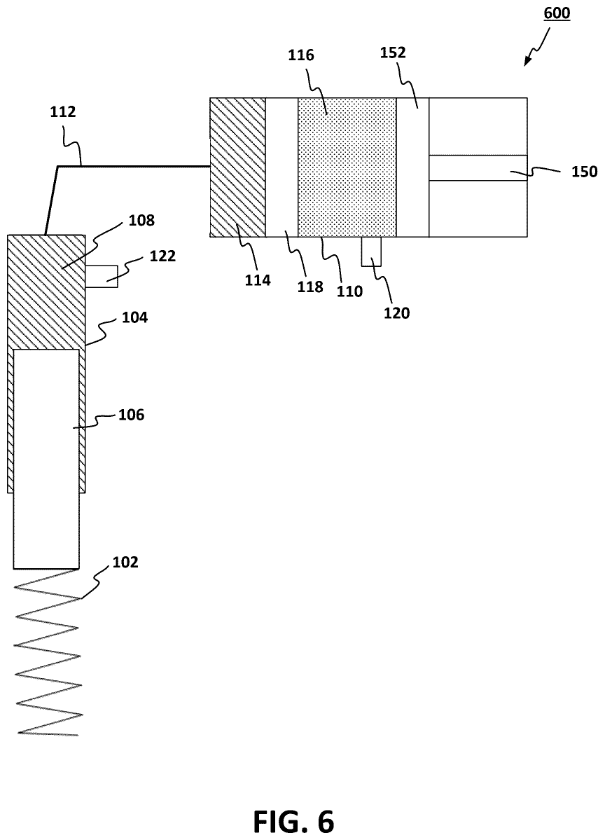

With reference now to FIG. 6, a dual rate spring system 600 with an volume adjusting actuator 150. Dual rate spring system 600 can have the same features and capabilities of dual rate spring system 100 of FIGS. 1A-D, dual rate spring system 300 of FIG. 3, and/or dual rate spring system 400 of FIG. 4. For example, dual rate spring system 600 can include two-way valve 130, fluid pump 132, and/or gas pump 134.

In one embodiment, volume adjusting actuator 150 can adjust or move a position of a piston 152 within additional volume reservoir 110 to change a volume of gas filled portion 116. For example, volume adjusting actuator 150 can move piston 152 closer to a proximal end of additional volume reservoir 110 (toward fluid filled portion 114) or closer to a distal end of additional volume reservoir 110 (away from fluid filled portion 114). Changing the volume of gas filled portion 116 can change a pressure of the gas in gas filled portion 116 and therefore adjust a spring rate of the second spring 104 and the overall spring rate of dual rate spring system 400. In one embodiment, volume adjusting actuator 150 can be adjusted or moved to cause fluid in fluid filled portion 114 to flow into damper portion 108 and cause hydraulic piston 106 to extend further out of damper portion 108. Thus ride height of the vehicle can be adjusted by adjusting the distance that hydraulic piston 106 extends out of damper portion 108.

### Hydraulic Dual Rate Spring With a Bump Stop

With reference to FIG. 1A, dual rate spring system 100 can be tuned or adjusted such that second spring 104 acts as a bump stop for first spring 102. Second spring 104 acting as a bump stop for first spring 102 can prevent a vehicle from bucking. For example, second spring 104 can be used to absorb spring energy from first spring 102 when first spring 102 bottoms out. In this example, second spring 104 may not act as a second spring in a dual spring system but rather as an energy dissipating bump stop for when a coil of first spring 102 binds. In one embodiment, a pressure of gas filled portion 116 is tuned or set to a pressure that causes the spring rate of second spring 104 to be greater than a spring rate of first spring 102. Therefore, second spring 104, with the higher pressure, may not engage until first spring 102 bottoms out or experiences coil bind. In one embodiment, rebound dampening can be added to create hysteresis and energy dissipation in the spring curve of dual rate spring system 100 to prevent the vehicle from bucking when first spring 102 bottoms out.

In one embodiment, first spring 102 can reach the end of available travel and go to coil bind and then second spring 104, with the higher pressure that matches the coil bind force of first spring 102, will engage and a spring curve for dual rate spring system 100 will then progressively increase to dissipate the energy caused by the coil bind. In one embodiment, second spring 104 can be pressurized at a higher pressure than the coil bind force of first spring 102 such that the spring curve of dual rate spring system 100 will linearly increase at steeper slope until second spring 104 in engaged and then the spring curve for dual rate spring system 100 will progressively increase as second spring 104 is engaged. Dampening can be adjusted in both directions such that dual rate spring system 100 is a velocity dependent suspension system rather than a position dependent suspension system.

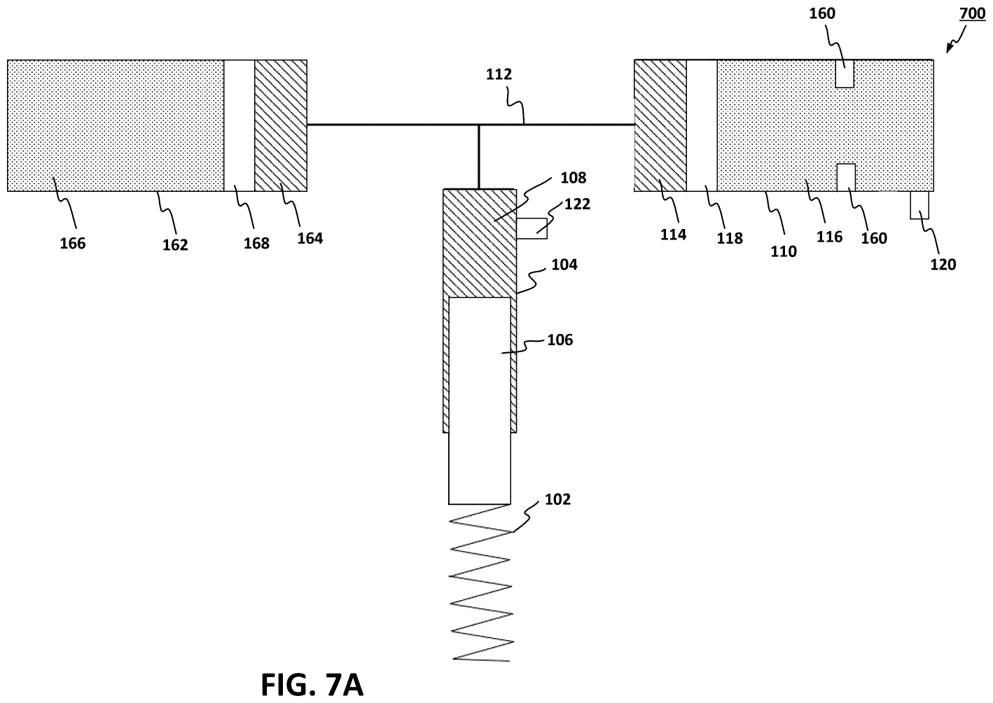

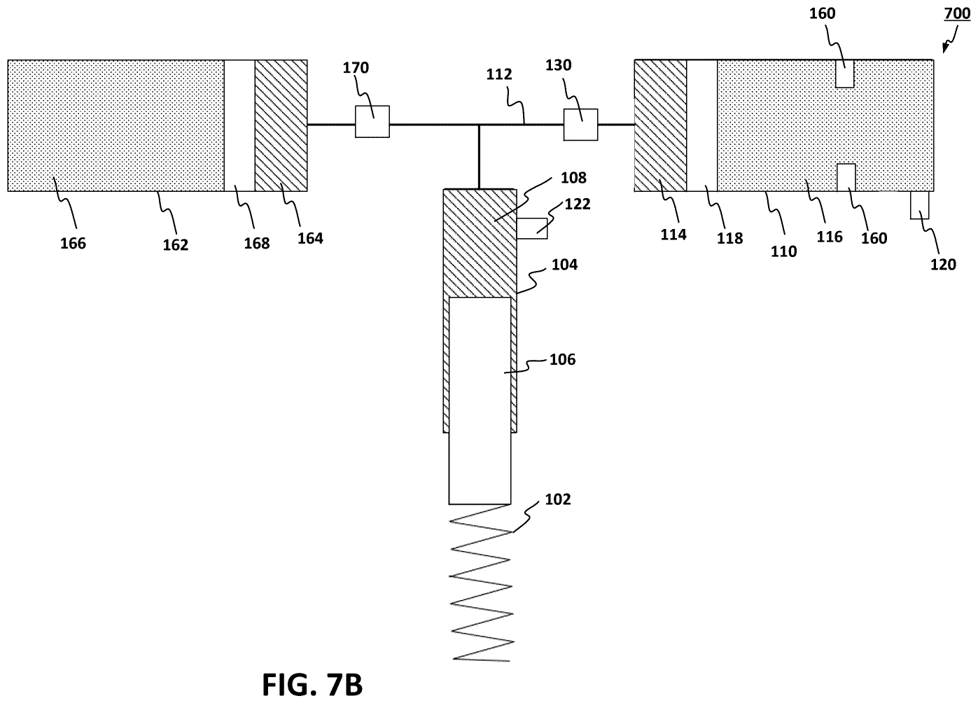

With reference now to FIG. 7A, a dual rate spring system 700 with a mechanical stop 160 in gas filled portion 116. Dual rate spring system 700 also includes a second additional volume reservoir 162 with a fluid filled portion 164, a gas filled portion 166 and a floating piston 168. In one embodiment, additional volume reservoir 110 can function with a gas pressure to allow second spring 104 to have a spring curve similar to curve 204 and curve 206 of FIG. 2A until floating piston 118 reaches mechanical stop 160. Once floating piston 118 reaches mechanical stop 160 then fluid from damper portion 108 will travel through fluid pathway 112 to fluid filled portion 164 of second additional volume reservoir 162. A pressure in gas filled portion 166 can be greater than that of gas filled portion 116 and can match or exceed a bottom out force or coil end force of first spring 102. Thus the fluid in fluid filled portion 164 may not move floating piston 168 to compress gas filled portion 166 until or after first spring 102 bottoms out. Thus, second additional volume reservoir 162 with the high pressure of gas filled portion 166 can act to dissipate an energy from first spring 102 bottoming out and prevent a vehicle from bucking. The mechanical stops 160 and second additional volume reservoir 162 can act as a bump stop for dual rate spring system 700 while maintain additional volume reservoir 110 as a second spring 104 in the dual spring system.

With reference now to FIG. 7B a dual rate spring system 700 including two-way valve 130 and two-way valve 170. Two-way valve 170 can have all the same features and capabilities of two-way valve 130. Two-way valve 170 can be placed in fluid pathway 112 leading to second additional volume reservoir 162. Two-way valve 170 can be used for rebounding in a similar manner to what is described above for two-way valve 130.

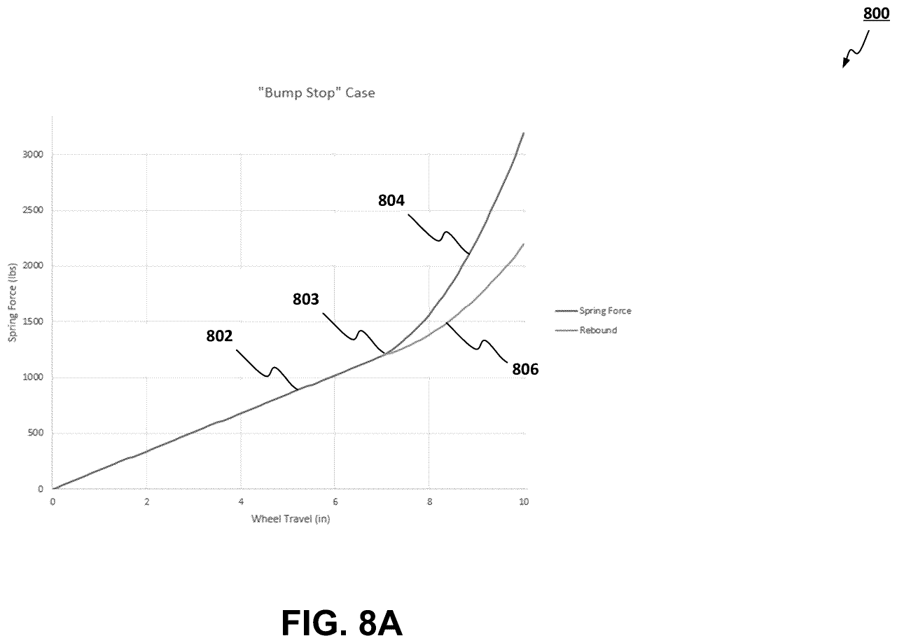

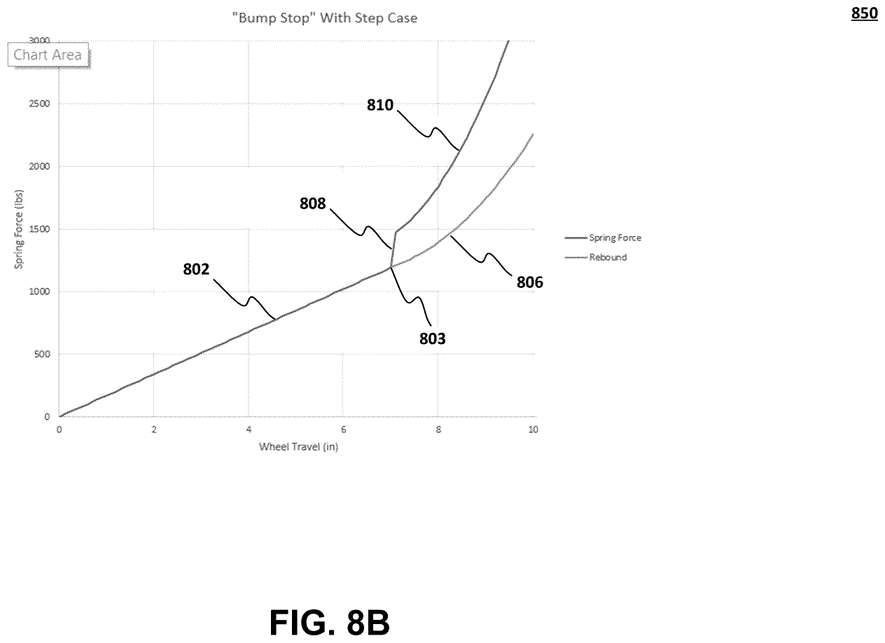

With reference now to FIG. 8A, a graph 800 depicting a force displacement curve for a bump stop embodiment as described above. Graph 800 can represent a bump stop force curve for either an embodiment described in reference to FIG. 1A or in reference to FIGS. 7A and 7B. Curve 802 depicts a linear spring force associated with first spring 102. Point 803 depicts where first spring 102 experiences a bottoming out or a coil bind. After point 803, curve 804 depicts a progressive curve representing the spring force curve of a gas filled portion of an additional volume reservoir that has a pressure equal to or similar to a bottoming out force of first spring 102. The progressive curve of curve 804 does not engage until first spring 102 bottoms out. Curve 806 depicts a rebound force of the additional volume reservoir with dampening.

With reference now to FIG. 8B, a graph 850 depicting a force displacement curve for a bump stop embodiment as described above. Graph 850 can represent a bump stop force curve for either an embodiment described in reference to FIG. 1A or in reference to FIGS. 7A and 7B. Graph 850 depicts a “step case” where a gas pressure in a gas filled portion of an additional reservoir is greater than a bottoming out or coil end force of first spring 102. Thus the force curve will step up until the gas filled portion with the greater pressure engages. Curve 802, point 803, and curve 806 are the same or similar as depicted in graph 800. Curve 808 depicts the step up or steeper linear slope relative to the linear slope of curve 802. Curve 808 depicts the portion of the spring curve after first spring 102 has bottomed out and before the gas filled portion with the force greater than the bottoming out force has been engaged. Curve 810 depicts the portion of the spring force curve after the gas filled portion has been engaged. Curve 810 depicts a more progressive spring force curve as opposed to a linear spring force curve.

### Hydraulic Dual Rate Spring With a Crossover Point

With reference now to FIG. 3, two-way valve 130 can be used to create a semi-active dual rate spring system with a crossover point. For example, graph 500 of FIG. 5A depicts a dual rate spring system that can be toggled or switched between two different spring rate curves using two-way valve 130. Curve 502 can be described as a linear curve of first spring 102 where two-way valve 130 has shut off second spring 104. Curve 504 can be described as an overall spring curve that has portions of spring force curves associated with both first spring 102 and second spring 104. First spring 102 can be considered to have a stiffer spring force as compared to second spring 104 and second spring 104 can be considered to have a more tender spring force as compared to first spring 102.

In one embodiment, switching a dual rate spring system from curve 502 to curve 504, or vice versa, using two-way valve 130 can be a crossover point. The dual rate of curve 504 can be employed for typical vehicle use that allows for the responsiveness of a dual spring curve without requires a crossover ring. This single rate spring curve can then be switched to for vehicle stability and additional capacity when desired. In one embodiment, two-way valve 130 can employ input from a vehicle sensor 131 to determine crossover points to switch between a dual spring force curve and single spring force curve. Vehicle sensor 131 can provide input related to data of the vehicle steering wheel position, brake pedal position, inertial measurement unit, etc. Two-way valve 130 use of input from vehicle sensor 131 can be employed to assist with prevent a vehicle roll or dive or assist with squat control.

For example, steering wheel position input can be used to determine that a vehicle is turning left. During the left turn, two-way valves associated with dual rate spring systems on the right side of the vehicle can close valves. Then the dual rate spring systems on the right side of the vehicle are experiencing the linear force curves of curve 502 while the dual rate spring systems of the left side of the vehicle are experiences the dual rate spring curves of curve 504. This can assist in preventing a rollover of the vehicle. Vehicle sensor 131 can communicate wireless to two-way valve 130 or can be hard-wired to two-way valve 130. Vehicle sensor 131 can send data indirectly to two-way valve 130 through a central vehicle network. In one embodiment, vehicle sensor 131 can sense load data that the vehicle is loaded with cargo at a predetermined threshold. Based on this load data, two-way valve 130 can lock out fluid flow to additional volume reservoir 110 and cause dual rate spring systems of the vehicle to operate at a spring rate with a linear curve such as curve 502. After vehicle sensor 131 determines that the vehicle is loaded below the predetermined threshold, two-way valve 130 can open the valves to flow the fluid to the additional volume reservoir 110 and the dual rate spring systems of the vehicle to can operate at a spring rate with a dual rate curve such as curve 504. In one embodiment, vehicle sensor 131 can provide temperature data to two-way valve 130 which can then operate the valves to change the spring curve of second spring 104 dependent upon temperature.

### Hydraulic Dual Rate Spring With Limits

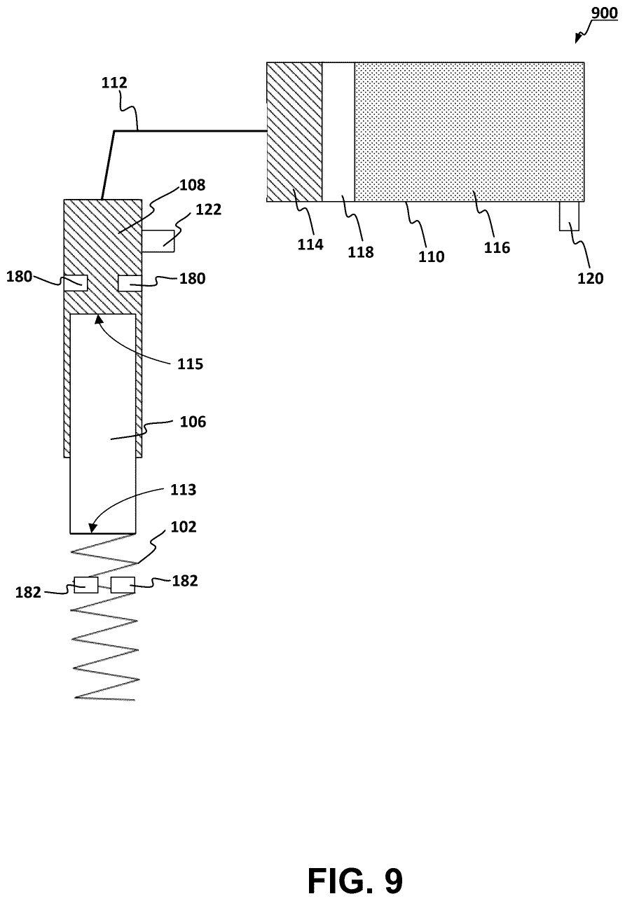

With reference now to FIG. 9, which depicts dual rate spring system 900 including piston limits 180 and spring limits 182. Piston limits 180 can place mechanical limits on how far hydraulic piston 106 is able to travel into damper portion 108. Piston limits 180 can be placed within damper portion 108 or otherwise configured to adjust a spring rate of second spring 104. Surface 115 of hydraulic piston 106 can contact piston limits 180. Spring limits 182 can place mechanical limits on where or at what position first spring 102 bottoms out at. Spring limits 182 can be used to adjust a spring rate of first spring 102 without changing first spring 102 for a different spring.

Hydraulic Dual Rate Spring with Gas Above Spring

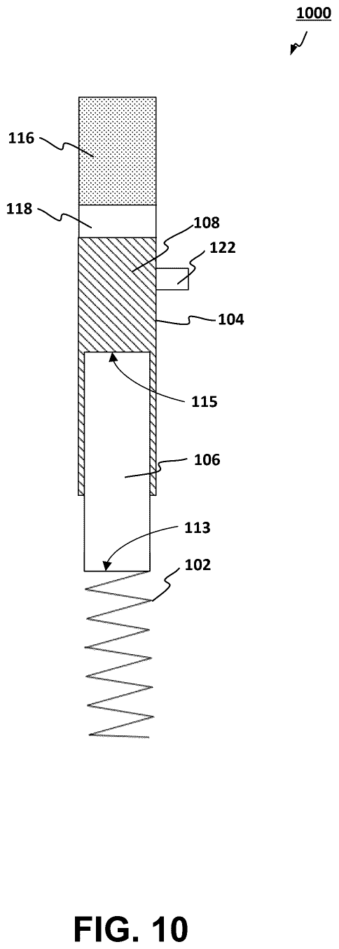

With reference now to FIG. 10, which dual rate spring system 1000 with gas filled portion 116 directly above and in line with first spring 102 and damper portion 108.

Hydraulic Dual Rate Spring with Gas Above Spring

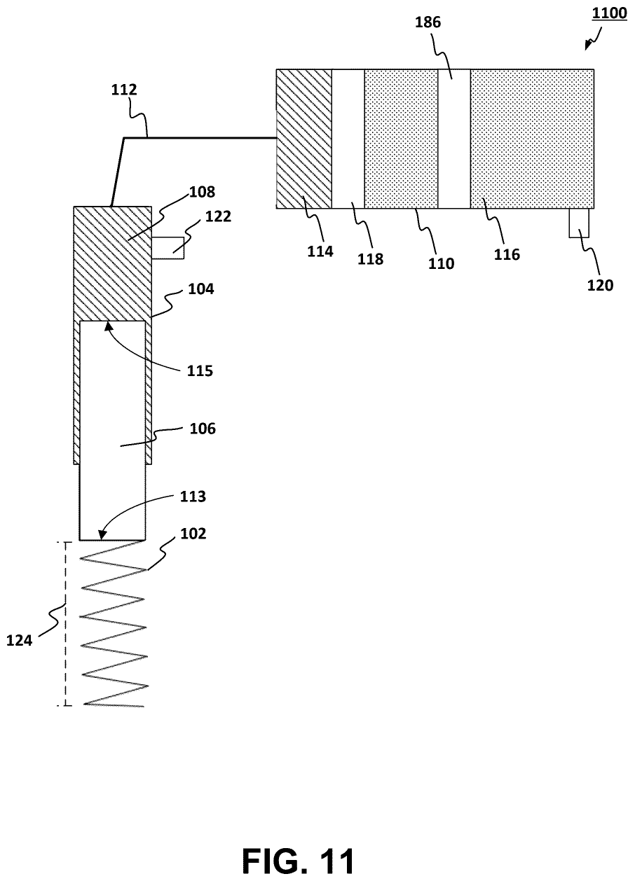

With reference now to FIG. 11, which dual rate spring system 1100 with a second floating piston 186 within gas filled portion 116. Second fluid pathway 186 can be employed for further adjustability to a spring rate of second spring 104 and/or dampening of second spring 104.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

The foregoing Description of Embodiments is not intended to be exhaustive or to limit the embodiments to the precise form described. Instead, The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims and their equivalents.

1. A dual rate spring system comprising:
a first spring with a first spring rate;
a second spring with a second spring rate, in series with said first spring, said second spring comprising:
a damper portion, filled with a fluid;
a hydraulic piston in contact with said first spring at a first end of said hydraulic piston and configured to telescopically move into and out of said damper portion at a second end of said hydraulic piston;
an additional volume reservoir in fluid communication with said damper portion via a fluid pathway, said additional volume reservoir comprising:
a fluid filled portion filled with said fluid;
a gas filled portion filled with gas; and
a floating piston that movably separates said fluid filled portion from said gas filled portion within said additional volume reservoir.

2. The dual rate spring system of claim 1, further comprising:
a two-way valve to adjust said second spring rate by controlling a first fluid flow rate in a compression direction and a second fluid flow rate in a rebound direction of said fluid between said dampening chamber and said fluid filled portion of said additional volume reservoir.

3. The dual rate spring system of claim 2, wherein said two-way valve controls a ride height of a vehicle associated with said dual rate spring system by closing fluid flow in a compression direction after a compression event until said fluid flows back to said damper portion causing said hydraulic piston to nearly fully extend from said damper portion.

4. The dual rate spring system of claim 2, wherein said two-way valve passively controls said first fluid flow rate and said second fluid flow rate.

5. The dual rate spring system of claim 2, wherein said two-way valve is electronically controlled.

6. The dual rate spring system of claim 2, wherein said two-way valve changes said second spring rate of said second spring at a crossover point based on input data from a vehicle sensor.

7. The dual rate spring system of claim 1, wherein said first spring is a mechanical spring or an air spring.

8. The dual rate spring system of claim 1, wherein said second spring rate of said second spring is velocity dependent.

9. The dual rate spring system of claim 1, wherein said additional volume reservoir is physically remote from said damper portion.

10. The dual rate spring system of claim 1, wherein said additional volume reservoir and said gas filled portion is in line with and directly above said first spring and said damper portion.

11. The dual rate spring system of claim 1, wherein said gas filled portion has a pressure equal to or greater than a bottoming out force of said first spring such that said gas filled portion is a bump stop to dissipate energy from said first spring after said first spring bottoms out.

12. The dual rate spring system of claim 1, further comprising:
a mechanical stop in said gas filled portion; and
a second additional volume reservoir in fluid communication with said damper portion and said additional volume reservoir via said fluid pathway, said second additional volume reservoir comprising:
a second fluid filled portion filled with said fluid;
a second gas filled portion filled with gas at a pressure equal to or greater than a bottoming out force of said first spring; and
a second floating piston that movably separates said second fluid filled portion from said second gas filled portion within said second additional volume reservoir; and
wherein said second additional volume reservoir is a bump stop to dissipate energy from said first spring after said first spring bottoms out and floating piston contacts said mechanical stop.

13. The dual rate spring system of claim 1, further comprising:
a gas valve coupled to said gas filled portion to add or remove said gas from said gas filled portion to adjust said second spring rate.

14. The dual rate spring system of claim 1, further comprising:
a fluid valve coupled to said fluid filled portion to add or remove said fluid from said fluid filled portion to adjust said second spring rate.

15. The dual rate spring system of claim 1, further comprising:
a gas pump coupled to said gas filled portion to add or remove said gas from said gas filled portion to adjust said second spring rate.

16. The dual rate spring system of claim 1, further comprising:
a fluid pump coupled to said fluid filled portion to add or remove said fluid from said fluid filled portion to adjust said second spring rate.

17. The dual rate spring system of claim 1, further comprising:
a volume adjusting actuator to move a piston to expand or contract a volume of said gas filled portion.

18. The dual rate spring system of claim 1, further comprising:
piston limits within said damper portion to mechanically limit how far said hydraulic piston is able to travel within said damper portion to control said second spring rate.

19. The dual rate spring system of claim 1, further comprising:
spring limits within said first spring to mechanically limit how far said first spring is able to compress before bottoming out to control said first spring rate.

20. The dual rate spring system of claim 1, further comprising:
a second floating piston within said gas filled portion to adjust said second spring rate.

21. A dual rate spring system comprising:
a first spring with a first spring rate;
a second spring with a second spring rate, in series with said first spring, said second spring comprising:
a damper portion, filled with a fluid;
a hydraulic piston in contact with said first spring at a first end of said hydraulic piston and configured to telescopically move into and out of said damper portion at a second end of said hydraulic piston;
an additional volume reservoir in fluid communication with said damper portion via a fluid pathway, said additional volume reservoir comprising:
a fluid filled portion filled with said fluid;
a gas filled portion filled with gas;
a floating piston that movably separates said fluid filled portion from said gas filled portion within said additional volume reservoir; and
a two-way valve to adjust said second spring rate by controlling a first fluid flow rate in a compression direction and a second fluid flow rate in a rebound direction of said fluid between said dampening chamber and said fluid filled portion of said additional volume reservoir, wherein said two-way valve controls a ride height of a vehicle associated with said dual rate spring system by closing fluid flow in a compression direction after a compression event until said fluid flows back to said damper portion causing said hydraulic piston to a predetermined distance extended from said damper portion.

22. A dual rate spring system comprising:
a first spring with a first spring rate;
a second spring with a second spring rate, in series with said first spring, said second spring comprising:
a damper portion, filled with a fluid;
a hydraulic piston in contact with said first spring at a first end of said hydraulic piston and configured to telescopically move into and out of said damper portion at a second end of said hydraulic piston;
an additional volume reservoir in fluid communication with said damper portion via a fluid pathway, said additional volume reservoir comprising:
a fluid filled portion filled with said fluid;
a gas filled portion filled with gas;
a floating piston that movably separates said fluid filled portion from said gas filled portion within said additional volume reservoir;
a mechanical stop in said gas filled portion;
a second additional volume reservoir in fluid communication with said damper portion and said additional volume reservoir via said fluid pathway, said second additional volume reservoir comprising:
a second fluid filled portion filled with said fluid;
a second gas filled portion filled with gas at a pressure equal to or greater than a bottoming out force of said first spring; and
a second floating piston that movably separates said second fluid filled portion from said second gas filled portion within said second additional volume reservoir; and
wherein said second additional volume reservoir is a bump stop to dissipate energy from said first spring after said first spring bottoms out and floating piston contacts said mechanical stop.

23. A dual rate spring system comprising:
a first spring with a first spring rate;
a second spring with a second spring rate, in series with said first spring, said second spring comprising:
a damper portion, filled with a fluid;
a hydraulic piston in contact with said first spring at a first end of said hydraulic piston and configured to telescopically move into and out of said damper portion at a second end of said hydraulic piston;
an additional volume reservoir in fluid communication with said damper portion via a fluid pathway, said additional volume reservoir comprising:
a fluid filled portion filled with said fluid;
a gas filled portion filled with gas;
a floating piston that movably separates said fluid filled portion from said gas filled portion within said additional volume reservoir; and
a two-way valve to adjust said second spring rate by controlling a first fluid flow rate in a compression direction and a second fluid flow rate in a rebound direction of said fluid between said dampening chamber and said fluid filled portion of said additional volume reservoir, wherein said two-way valve changes said second spring rate of said second spring at a crossover point based on input data from a vehicle sensor.
